(19) United States
(12) Patent Application Publication
(10) Pub. No.: US 2011/0111622 A1
(43) Pub. Date: May 12, 2011

(54) ELECTRIC WIRING STRUCTURE OF HOLLOW ROTATOR

(75) Inventors: Junji Koyama, Nagano (JP); Naoki Kanayama, Nagano (JP)

(73) Assignee: Harmonic Drive Systems Inc., Shinagawa-ku (JP)

(21) Appl. No.: 13/002,536

(22) PCT Filed: Jul. 23, 2008
(86) PCT No.: PCT/JP2008/001968

§ 371 Date: Jan. 4, 2011

(51) Int. Cl. H01R 3/00

(52) U.S. Cl. 439/577

(57) ABSTRACT

A relay connector is secured to a hollow hole forming member provided with a hollow hole in a hollow rotator so as to be coaxially located in the hollow hole in order to draw out an electric wire group from the side of one end surface in the direction of a rotation central axis line of the hollow rotator to the side of the other end surface by using the hollow hole passing through in the direction of the rotation central axis line in the hollow rotator. A first connection section is formed on one end of the direction of the rotation central axis line of the relay connector and a second connection section is formed on the other end thereof. A first electric wire side connector attached to the end of a first electric wire group is electrically and detachably connected to the first connection section and a second electric wire side connector attached to the end of a second electric wire group is electrically and detachably connected to the second connection section.

### TECHNICAL FIELD

The present invention relates to a wiring structure of a hollow rotator such as a hollow motor, a hollow reduction device, or a hollow actuator configured to connect a hollow motor and a hollow reduction device in coaxial fashion. More particularly, the present invention relates to an electric wiring structure of a hollow rotator wherein a hollow hole passing through such a hollow rotator in the direction of the rotation central axis line is used to draw a large number of electric wires from one end surface of the hollow rotator to another end surface in the direction of the rotation central axis line.

### BACKGROUND ART

Hollow rotators are used in robotic arms and the like, and are used in order to accommodate pneumatic lines or drive shafts, as well as signal lines for transmitting laser or other optical signals, electric drive power, control signals, or the like. Patent Documents 1 and 2 disclose a joint structure for a robot or other device wherein a hollow hole of a hollow reduction device is used as a space for cable wiring and piping. Patent Document 3 discloses a robotic arm configured so that a cable having connectors mounted at either end is drawn out via a hollow hole of an amplifier-integrated actuator device.
[Patent Document 1] JP-A 06-143186
[Patent Document 2] JP-A 07-108485
[Patent Document 3] JP-A 2005-237168

### DISCLOSURE OF THE INVENTION

### Problems to be Solved by the Invention

When an electric wire having a connector is to be passed through the hollow hole in the hollow rotator, the number of wires that can pass through the hollow hole is limited by the size of the connector because the connector is generally thicker than the electric wire, leading to inefficient use of the hollow hole. As disclosed in Patent Document 3, in a case where a connector is mounted on either end of the electric wire after the electric wire is passed through the hollow hole, the hollow hole can be used efficiently and a greater number of electric wires can pass through the hole. However, in this case, it becomes necessary to perform work to disconnect the wires passing through the hollow hole, or to detach the connectors mounted on the wires, when the rotator is removed during maintenance and inspection or the like.

In light of such issues, it is an object of the present invention to provide an electric wiring structure of a hollow rotator in which a hollow hole can be efficiently used to dispose a large number of electric wires and in which there is no need to perform work in removing the electric wires from the hollow hole during maintenance and inspection or the like.

### Means Used to Solve the Problems

In order to solve the above-mentioned problems, the present invention provides an electric wiring structure of a hollow rotator wherein a hollow hole passing through the hollow rotator in a direction of a rotation central axis line is used to draw an electric wire group from one end surface of the hollow rotator in the direction of the rotation central axis line to another end surface thereof, wherein the structure is characterized in that:

a relay connector is fixed to a hollow hole forming member provided with the hollow hole in the hollow rotator so as be coaxially positioned inside the hollow hole;

a first connection section is formed in one end of the relay connector in the direction of the rotation central axis line, and a second connection section is formed in another end thereof;

the electric wire group is divided into a first electric wire group disposed to one side of the hollow rotator in the direction of the rotation central axis line, and a second electric wire group disposed to another side;

a first electric wire side connector attached to an end of the first electric wire group is electrically connected in a detachable state to the first connection section; and

a second electric wire side connector attached to an end of the second electric wire group is electrically connected in a detachable state to the second connection section.

The relay connector is fixed inside the hollow hole, and the first electric wire side connector of the first electric wire group; and the second electric wire side connector of the second electric wire group are connected to the first and second connection sections, respectively, of the relay connector. There is accordingly no need to pass an electric wire group composed of the connected first and second electric wire groups into the hollow hole. The relay connector can also be made a single-purpose connector integrated with the hollow hole, allowing the hollow hole to be used in a more efficient manner. The wiring also can be attached and detached by inserting and removing the first electric wire side connector of the first electric wire group relative to the first connection section of the relay connector, and inserting and removing the second electric wire side connector of the second electric wire group relative to the second connection section of the relay connector. The work involved with attaching and detaching the groups of wires when the hollow rotator is maintained and inspected is accordingly simplified.

In the electric wiring structure of a hollow rotator according to the present invention,

the relay connector may be configured from a first relay connector and a second relay connector electrically connected in a coaxial manner in a detachable state;

the first connection section may be formed in the first relay connector, and the second connection section may be formed in the second relay connector; and

a fixing mechanism capable of fixing the first and second relay connectors to the hollow hole forming member in a detachable state may be configured between an internal peripheral surface of the hollow hole of the hollow hole forming member, and the first and second relay connectors.

In the electric wiring structure of a hollow rotator according to the present invention,

the hollow hole forming member can be made a rotating-side member that rotates around the rotation central axis line; and

at least one connection section among the first and second connection sections in the relay connector can be made capable of rotating around the rotation central axis line via a slip ring.

The first electric wire group connected to the fixed side can thus be electrically connected, for example, via the relay connector to the second electric wire group connected to the rotating side.

Next, the present invention provides an electric wiring structure of a hollow rotator wherein a hollow hole passing through the hollow rotator in a direction of a rotation central axis line is used to draw an electric wire group from one end surface of the hollow rotator in the direction of the rotation central axis line to another end surface thereof, wherein the structure is characterized in that:

the electric wire group is divided into a first electric wire group disposed to one side of the hollow rotator in the direction of the rotation central axis line, and a second electric wire group disposed to another side;

a first relay connector is attached to an end of the first electric wire group;

a second relay connector is attached to an end of the second electric wire group;

the first and second relay connectors are configured to be able to be coaxially joined in a removable state;

the first relay connector and the second relay connector are fixed to a hollow hole forming member provided with the hollow hole in the hollow rotator so as to be coaxially positioned inside the hollow hole; and

a fixing mechanism for fixing each of the first and second relay connectors to an internal peripheral surface of the hollow hole of the hollow hole forming member in a removable state is provided between the internal peripheral surface, and each of the first and second relay connectors.

### Effect of the Invention

In the electric wiring structure of a hollow rotator according to the present invention, a relay connector is fixed inside a hollow hole in the hollow rotator. An electric wire group that is passed through the hollow hole is divided into a first electric wire group provided with a first electric wire side connector that can be connected to the relay connector in a manner so as to be insertable thereinto and removable therefrom, and a second electric wire group provided with a second electric wire side connector. Wiring can accordingly be accomplished so that an electric wire group is passed through the hollow hole merely by connecting the first and second groups of wires from either end of the hollow hole to the relay connector.

According to the present invention, there is no need to pass an electric wire group having the connected first and second electric wire groups into the hollow hole. The relay connector can be made into a single-purpose connector integrated with the hollow hole, allowing the hollow hole to be used more efficiently. Furthermore, the wiring can be attached and detached by inserting and removing the first electric wire side connector of the first electric wire group relative to the first connection section of the relay connector, and inserting and removing the second electric wire side connector of the second electric wire group relative to the second connection section of the relay connector. The work involved with attaching and detaching the electric wire groups during maintenance and inspection of the hollow rotator is accordingly simplified.

### BRIEF DESCRIPTION OF THE DRAWINGS

FIG. 1 is a schematic longitudinal sectional view showing one example of a hollow reduction device to which the present invention can be applied;

FIG. 2 is an illustrative view showing Embodiment 1 of the present invention;

FIG. 3 is an illustrative view showing Embodiment 2 of the present invention; and

FIG. 4 is an illustrative view showing Embodiment 3 of the present invention.

### BEST MODE FOR CARRYING OUT THE INVENTION

The electric wiring structure of the hollow rotator of the present invention is described below with reference to the accompanying drawings.

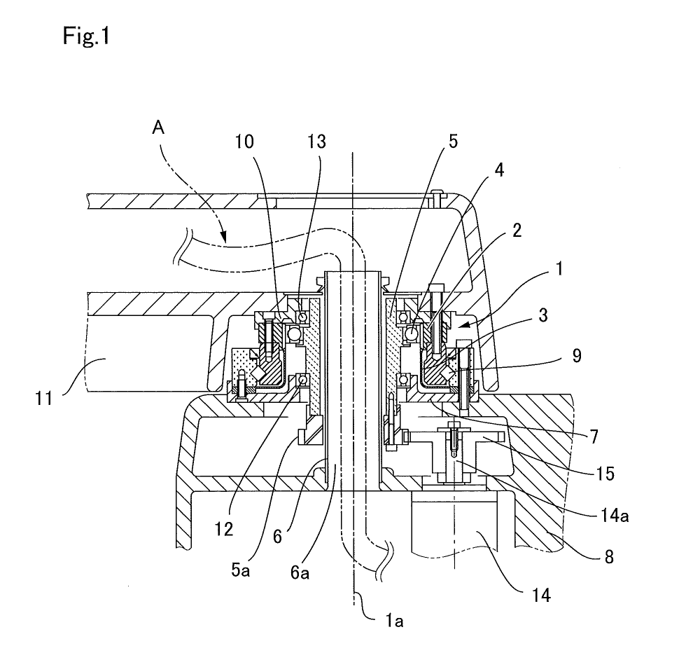

FIG. 1 is a schematic longitudinal cross-sectional view showing a hollow reduction device as one example of a hollow rotator to which the present invention can be applied. The hollow reduction device 1 shown in the drawing is a wave gear drive, and includes an annular circular spline 2, a flexible flexspline 3 having a “silk hat” shape, an elliptically contoured wave generator 4, and a hollow rotating shaft 5 formed integrally with the wave generator 4. It is of course possible for a hollow reduction device other than a wave gear drive to be used.

The flexspline 3 of the hollow reduction device 1 is fixed to a fixed-side frame 8 via a disc-shaped mounting flange 7. A cross roller bearing 9 is mounted between the flexspline 3 and the circular spline 2, and the two splines can rotate relative to each other. The circular spline 2 is fixed to a swing frame 11 via a disc-shaped mounting flange 10. The hollow rotating shaft 5 integrally formed with the wave generator 4 is supported in a rotatable state by the mounting flange 7 fixed to the fixed-side frame 8 and by the mounting flange 10 fixed to the swing frame 11, via bearings 12, 13, respectively. A cylindrical member 6 having one end fixed to the fixed-side frame 8 is disposed in a coaxial state on the inward side of the hollow rotating shaft 5. The cylindrical member 6 is a hollow hole forming member, and the inward side thereof forms a hollow hole 6a extending in the direction of a rotation central axis line 1a.

An external tooth 5a is formed on the external peripheral surface of the end part on the side of the hollow rotating shaft 5 facing the fixed-side frame 8. A motor 14 is mounted in the fixed-side frame 8, and a driving gear 15 fixed to an output shaft 14a of the motor 14 meshes with the external tooth 5a of the hollow rotating shaft 5.

The flexspline 3 of the hollow reduction device 1 is bent into an elliptical shape by the wave generator 4, and meshes with the circular spline 2 at both ends of the major axis of the ellipse. When the motor 14 is driven and the hollow rotating shaft 5 of the hollow reduction device 1 rotates, the rotation of the wave generator 4 integrally formed therewith causes the positions at which the flexspline 3 and the circular spline 2 are enmeshed with each other to move in the circumferential direction. Relative rotation is thereby generated between the flexspline 3 and the circular spline 2 in accordance with the difference in the number of teeth therebetween. The flexspline 3 is fixed to the fixed-side frame 8, and therefore the circular spline 2 rotates, and the swing frame 11 upon which the circular spline 2 is mounted swings around the rotation central axis line 1a.

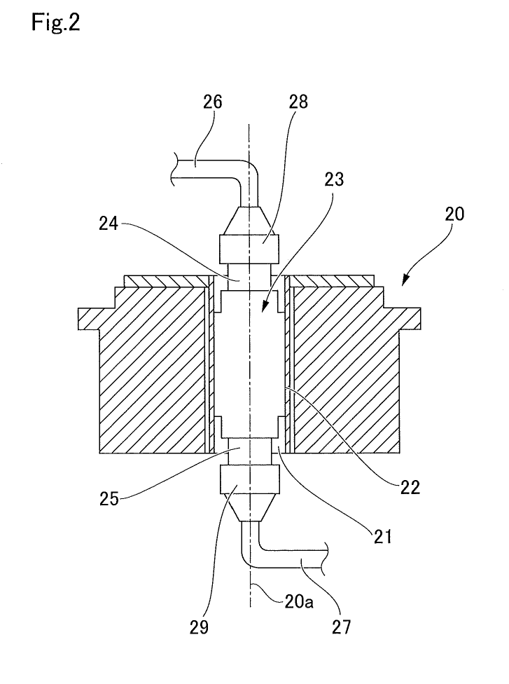

Here, an electric wire group is drawn out from the side of the fixed-side frame 8 to the side of the swing frame 11 via the hollow hole 6a of the hollow reduction device 1. In conventional practice, a wiring cable in which a large number of wires are bundled together is passed through the hollow hole 6a, as shown by the imaginary line A in the drawing. In contrast, the hollow hole 6a is utilized to dispose a large number of wires in a case in which the electric wiring structure according to the present invention is used, as shown in FIGS. 2 to 4.

### Embodiment 1

FIG. 2 is an illustrative view showing the electric wiring structure according to Embodiment 1 of the present invention. A hollow rotator 20 is schematically shown in the drawing to facilitate understanding, and may, for example, be the hollow reduction device 1 shown in FIG. 1.

A hollow hole 21 of a circular cross section passing through in the direction of a rotation central axis line 20a of the hollow rotator 20 is formed in the center of the hollow rotator 20. A cylindrical hollow hole forming member 22 (the cylindrical member 6 in the example of FIG. 1) in which the hollow hole 21 is formed is mounted, for example, on the fixed side of the hollow rotator 20 (mounted on the fixed-side frame 8 in the example of FIG. 1).

A relay connector 23 is integrally formed with the hollow hole forming member 22, so as to be positioned coaxially inside the hollow hole 21. A first connection section 24 is formed in one end of the relay connector 23 in the direction of the rotation central axis line 20a, and a second connection section 25 is formed in the other end thereof. The first and second connection sections 24, 25 include, for example, a large number of pinholes (not shown). The pinholes in each corresponding pair are electrically connected to each other.

While, the wires disposed via the hollow hole 21 are divided into a first electric wire group 26 disposed to one side in the direction of the rotation axis line, and a second electric wire group 27 disposed to the other side, with the hollow rotator 20 disposed therebetween. A first electric wire side connector 28 is mounted on the end of the first electric wire group 26. The first electric wire side connector 28 includes a large number of connector pins (not shown), and is made insertable into and removable from the pinholes of the first connection section 24 of the relay connector 23. A second electric wire side connector 29 is mounted on the end of the second electric wire group 27 in the same manner. The second electric wire side connector 29 includes a large number of connector pins (not shown), and is made insertable into and removable from the pinholes of the second connection section 25 of the relay connector 23.

In the electric wiring structure of Embodiment 1, a wiring state wherein the electric wire groups are passed through the hollow hole 21 is formed merely by connecting the first and second electric wire groups 26, 27 from either side of the hollow hole 21 to the relay connector 23. It is therefore unnecessary to thread the large number of electric wire groups inside the hollow hole 21. The relay connector 23 is a single-purpose connector integrated with the hollow hole 21, allowing the hollow hole 21 to be used in a more efficient manner. Furthermore, the wiring can be attached and detached by inserting and removing the first electric wire side connector 28 of the first electric wire group 26 relative to the first connection section 24 of the relay connector 23, and inserting and removing the second electric wire side connector 29 of the second electric wire group 27 relative to the second connection section 25 of the relay connector 23. The work involved with attaching and detaching the electric wire groups when maintenance and inspection are performed on the hollow rotator 20 is accordingly simplified.

### Embodiment 2

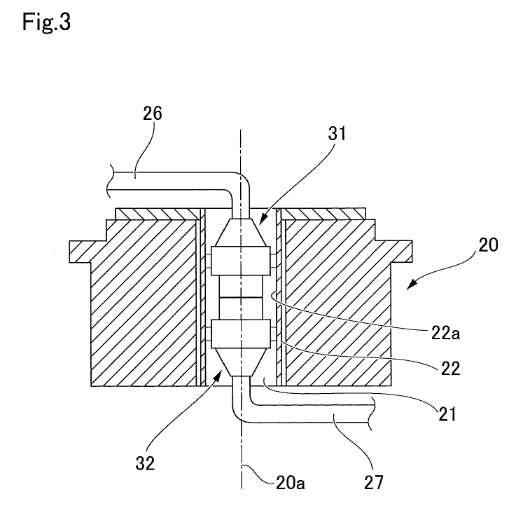

FIG. 3 is an illustrative view schematically showing the electric wiring structure according to Embodiment 2 of the present invention. In Embodiment 2, the relay connector 23 is configured from a first relay connector 31 and a second relay connector 32 electrically connected in a coaxial manner in a detachable state. A fixing mechanism for fixing the first and second relay connectors 31, 32 to a hollow hole internal peripheral surface 22a in a detachable state is provided between the internal peripheral surface 22a of the hollow hole 21 of the hollow hole forming member 22, and the first and second relay connectors 31, 32.

The first relay connector 31 corresponds to the first connection section 24 in Embodiment 1, and to the first electric wire side connector 28 of the first electric wire group 26 joined therewith. Similarly, the second relay connector 32 corresponds to the second connection section 25 in Embodiment 1, and to the second electric wire side connector 29 of the second electric wire group 27 joined therewith.

It is also possible to form the first connection section 24 on the first relay connector 31, the first connection section 24 being capable of being joined to the first electric wire side connector 28 in a removable state, and to form the second connection section 25 on the second relay connector 32, the second connection section 25 being capable of being joined to the second electric wire side connector 29 in a removable state. In this case, the first electric wire side connector 28 of the first electric wire group 26 may be joined to the first relay connector 31, and the second electric wire side connector 29 of the second electric wire group 27 may be joined to the second relay connector 32, in the same manner as in Embodiment 1.

Next, a male thread may be formed on the external peripheral surface portion of the first and second relay connectors 31, 32, and a female thread threadably engaged with the male thread may be formed in the internal peripheral surface of the hollow hole, as another example of a fixing mechanism. Of course, other fixing mechanisms may also be used.

### Embodiment 3

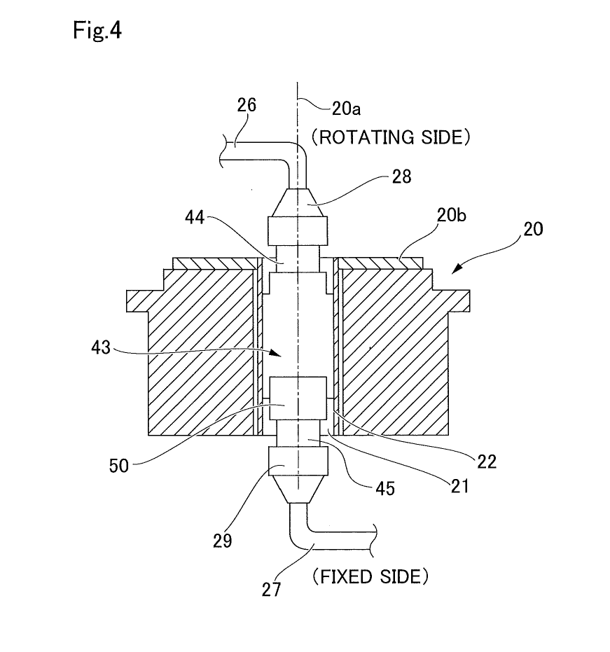

FIG. 4 is an illustrative view schematically showing the electric wiring structure according to Embodiment 3 of the present invention. One difference from Embodiment 1 is that the hollow hole forming member 22 is fixed to a rotating-side member 20b that rotates around the rotation central axis line 20a in the hollow rotator 20. Another difference is that at least one connection section among first and second connection sections 44, 45, such as the second connection section 45, in a relay connector 43 fixed inside the hollow hole 21 in a coaxial state is capable of rotating around the rotation central axis line 20a via a slip ring 50. The first electric wire side connector 28 attached to the first electric wire group 26, and the second electric wire side connector 29 attached to the second electric wire group 27 are joined in a removable state to the first and second connection sections 44, 45, respectively.

In a case where the hollow hole forming member 22 is joined to a fixed-side member of the hollow rotator 20, the first connection section 44 may be joined to the relay connector 43 via a slip ring. Both of the connection sections 44, 45 may also be made capable of rotating relative to the relay connector 43 via a slip ring.

1. An electric wiring structure of a hollow rotator wherein a hollow hole passing through the hollow rotator in a direction of a rotation central axis line is used to draw an electric wire group from one end surface of the hollow rotator in the direction of the rotation central axis line to another end surface thereof, wherein the electric wiring structure of a hollow rotator is wherein:
a relay connector is fixed to a hollow hole forming member provided with the hollow hole in the hollow rotator so as be coaxially positioned inside the hollow hole;
a first connection section is formed in one end of the relay connector in the direction of the rotation central axis line, and a second connection section is formed in another end thereof;
the electric wire group is divided into a first electric wire group disposed to one side of the hollow rotator in the direction of the rotation central axis line, and a second electric wire group disposed to another side;
a first electric wire side connector attached to an end of the first electric wire group is electrically connected in a detachable state to the first connection section; and
a second electric wire side connector attached to an end of the second electric wire group is electrically connected in a detachable state to the second connection section.

2. The electric wiring structure of a hollow rotator according to claim 1, wherein the electric wiring structure of a hollow rotator is wherein:
the relay connector is configured from a first relay connector and a second relay connector electrically connected in a coaxial manner in a detachable state;
the first connection section is formed in the first relay connector, and the second connection section is formed in the second relay connector; and
a fixing mechanism for fixing the first and second relay connectors to an internal peripheral surface of the hollow hole of the hollow hole forming member in a detachable state is provided between the internal peripheral surface, and the first and second relay connectors.

3. The electric wiring structure of a hollow rotator according to claim 1, wherein the electric wiring structure of a hollow rotator is wherein:
the hollow hole forming member is a rotating-side member that rotates around the rotation central axis line; and
at least one connection section among the first and second connection sections in the relay connector is capable of rotating around the rotation central axis line via a slip ring.

4. An electric wiring structure of a hollow rotator wherein a hollow hole passing through the hollow rotator in a direction of a rotation central axis line is used to draw an electric wire group from one end surface of the hollow rotator in the direction of the rotation central axis line to another end surface thereof, wherein the electric wiring structure of a hollow rotator is wherein:
the electric wire group is divided into a first electric wire group disposed to one side of the hollow rotator in the direction of the rotation central axis line, and a second electric wire group disposed to another side;
a first relay connector is attached to an end of the first electric wire group;
a second relay connector is attached to an end of the second electric wire group;
the first and second relay connectors are configured to be able to be coaxially joined in a removable state;
the first relay connector and the second relay connector are fixed to a hollow hole forming member provided with the hollow hole in the hollow rotator so as to be coaxially positioned inside the hollow hole; and
a fixing mechanism for fixing each of the first and second relay connectors to an internal peripheral surface of the hollow hole of the hollow hole forming member in a detachable state is provided between the internal peripheral surface, and each of the first and second relay connectors.
